(19) United States
(12) Patent Application Publication
(10) Pub. No.: US 2026/0336919 A1
(43) Pub. Date: Oct. 29, 2026

(54) SHIPPING CONTAINER TRANSPORTER APPARATUS WITH CASTERS MOVABLE BETWEEN RETRACTED POSITION AND EXTENDED POSITION

(71) Applicant: Michael J. DUFFEY, Cinnaminson, NJ (US)

(72) Inventor: Michael J. DUFFEY, Cinnaminson, NJ (US)

(21) Appl. No.: 19/657,763

(22) Filed: Apr. 24, 2026

Related U.S. Application Data
(60) Provisional application No. 63/794,172, filed on Apr. 24, 2025.
(60) Provisional application No. 63/818,361, filed on Jun. 5, 2025.

(51) Int. Cl. B65D 88/54; B65G 67/24

(52) U.S. Cl. CPC B65D 88/54; B65G 67/24

(57) ABSTRACT

The present disclosure relates to cargo transport and, more particularly, to apparatus for use with a shipping container and a floor, the apparatus comprising a transporter having a platform and a plurality of casters movable between a retracted position and an extended position. The present disclosure relates to cargo transport and, more particularly, to apparatus for use with a shipping container and a floor, the apparatus comprising a transporter having a platform and a plurality of casters movable between a retracted position and an extended position. The present disclosure relates to cargo transport and, more particularly, to apparatus for use with a shipping container and a floor, the apparatus comprising a transporter having a platform and a plurality of casters movable between a retracted position and an extended position.

### CROSS REFERENCE TO RELATED APPLICATIONS

This application claims the benefit of and priority to U.S. Provisional Patent Application No. 63/794172, filed Apr 24, 2025, and U.S. Provisional Patent Application No. 63/818,361, filed Jun. 5, 2025, the entireties of which are hereby incorporated herein by reference.

### FIELD OF INVENTION

The present disclosure relates generally to cargo transport and, more particularly, to the loading and unloading of cargo with respect to shipping containers.

### BACKGROUND

Shipping containers are widely used to transport cargo in a variety of commercial and industrial settings. Such containers commonly define an enclosed cargo space that is accessed through one or more doors, often at a rear end of the container, and cargo is moved into and out of the enclosed space during loading and unloading operations.

Conventional and established loading approaches can present operational constraints. The geometry of the container opening, the enclosed nature of the cargo space, and the weight and size of cargo can make loading and unloading cumbersome, time-consuming, or dependent upon external lifting or handling equipment. In some situations, known techniques can also limit the manner in which cargo is positioned, moved, or retrieved relative to the container.

Accordingly, there remains a need for improvements in the field of cargo transport to facilitate handling of cargo in relation to shipping containers.

### SUMMARY

Disclosed herein is an apparatus for use with a shipping container and a floor. The shipping container is of a type that, when operatively disposed on the floor, defines an interior horizontal surface presenting upwardly for receiving cargo. The apparatus comprises a transporter having a platform and a plurality of casters. The platform defines a load-supporting surface, and each of the plurality of casters is mounted to the platform for movement between a retracted position and an extended position. The plurality of casters are configured such that, when the transporter exits the shipping container with the plurality of casters commencing in the retracted position, each caster traverses to the extended position upon exiting the shipping container to support the platform for rolling movement on the floor while the load-supporting surface remains at a substantially constant elevation relative to the floor.

In some embodiments, each caster releasably locks upon movement to the extended position. In some embodiments, each caster has an associated trigger configured, when the apparatus is drawn into the shipping container from the floor, to release the caster for movement to the retracted position as the caster reaches the shipping container. In some embodiments, each caster has an associated actuator configured to move the caster to the extended position, and the actuator may comprise a spring configured to bias the caster toward the extended position. In some embodiments, each caster is configured to be urged by the interior horizontal surface to the retracted position. In some embodiments, the transporter is configured for rolling movement when each caster is in the retracted position. In some embodiments, the apparatus further comprises a roller positioned to support the platform while at least one of the plurality of casters moves between the retracted position and the extended position. In some embodiments, the apparatus further comprises a tow bar pivotably mounted to the platform. In some embodiments, the plurality of casters comprise swivel casters. In some embodiments, each caster is engageable with a stop member in the retracted position such that a wheel of the caster protrudes below the platform to support the platform for rolling movement while the transporter is in the shipping container.

Also disclosed herein is a cargo transport system comprising a shipping container having a floor and an opening, and the apparatus positioned for movement through the opening relative to the floor. In some embodiments, the cargo transport system further comprises an ejector coupled to the shipping container and configured to expel the transporter from the shipping container. In some embodiments, the ejector comprises a chain loop operatively mounted to the shipping container, a gripper plate operatively mounted to the chain loop and configured to engage the platform, and a motor operatively coupled to drive the chain loop. In some embodiments, the shipping container comprises a central rail mounted to the floor and disposed to be received in a central channel of the platform. In some embodiments, the platform defines a locator notch configured to receive the gripper plate. In some embodiments, the cargo transport system further comprises a grappler coupled to the shipping container and configured to draw the transporter into the shipping container, and the grappler may comprise a cable winch. In some embodiments, the platform carries a latch configured to releasably engage the gripper plate to move the platform with the gripper plate in both directions. In some embodiments, the cargo transport system further comprises a stability bracket positioned to engage a protruding flange on the platform when the platform is fully enclosed in the shipping container to secure the platform against sliding widthwise movement in the shipping container.

Further disclosed herein is a method of moving cargo relative to a shipping container, the shipping container comprising an interior horizontal surface and an opening. The method comprises disposing a transporter carrying the cargo adjacent the opening, the transporter comprising a platform and a plurality of casters mounted for movement between retracted positions and extended positions, causing the transporter to move through the opening into or out of the shipping container, and automatically moving the plurality of casters between the retracted positions and the extended positions responsive to the plurality of casters traversing the opening such that, when the transporter exits the shipping container, the platform is supported for rolling movement on a floor outside the shipping container while a load-supporting surface of the platform remains at a substantially constant elevation relative to the floor. In some embodiments, moving the transporter into the shipping container comprises engaging a trigger associated with each caster against the interior horizontal surface to release the caster for movement to the retracted position. In some embodiments, moving the transporter out of the shipping container comprises biasing each caster toward the extended position with an actuator as the caster exits the shipping container. In some embodiments, causing the transporter to move through the opening out of the shipping container comprises driving a gripper plate along a chain loop with a motor to urge the transporter outwardly. In some embodiments, causing the transporter to move through the opening into the shipping container comprises drawing the transporter inwardly with a cable winch. In some embodiments, causing the transporter to move through the opening into or out of the shipping container comprises towing the transporter with a tow bar pivotably mounted to the platform.

### BRIEF DESCRIPTION OF DRAWINGS

The accompanying drawings, which are incorporated herein and form part of the specification, illustrate example embodiments of the present disclosure and, together with the description, serve to explain principles of the present disclosure.

FIG. 1 is a top perspective view of a transporter comprising a platform and a plurality of caster assemblies, according to an example implementation of the disclosure.

FIG. 2 is a bottom perspective view of the transporter of FIG. 1 showing underside structure of the platform and the plurality of caster assemblies, according to an example implementation of the disclosure.

FIG. 3 is a detail view of a caster assembly with a castor in a retracted position with a locking plate in a release position.

FIG. 4 is a detail view of the caster assembly with the caster in an extended position.

FIG. 5 is another detail view of the caster assembly with the caster in the extended position.

FIG. 6 is another detail view of the caster assembly with the caster in the retracted position with the locking plate in the release position.

FIG. 7 illustrates a shipping container configured for use with the transporter.

FIG. 8 illustrates the transporter positioned adjacent to an opening of the shipping container.

FIG. 9 illustrates the platform and the plurality of casters relative to a floor outside the shipping container and a support surface of the shipping container.

FIG. 10 further illustrates the platform and the plurality of casters relative to a floor outside the shipping container and a support surface of the shipping container.

FIG. 11 illustrates the transporter loaded into the shipping container.

FIG. 12 illustrates a shipping container equipped with a platform grappler and ejector, according to an example implementation of the disclosure.

FIG. 13 is an enlarged view showing a portion of the grappler and ejector of FIG. 12 in greater detail.

FIG. 14 is an enlarged view showing an end of a central rail and a gripper plate of the grappler and ejector assembly of FIG. 12 in engagement with the platform of FIG. 1.

FIG. 15 is a further enlarged view showing the end of the rail and the gripper plate of the grappler and ejector assembly of FIG. 12, prior to engagement with the platform of FIG. 1.

FIG. 16 is a further enlarged view showing a cut-away portion of the platform and the central rail when the platform is loaded into the shipping container.

FIG. 17 is a detail view of a caster assembly that includes a swivel caster, showing the caster assembly in an extended position, according to a further example embodiment.

FIG. 18 illustrates a further example embodiment of a platform, including a tow bar pivotably mounted to the platform.

FIG. 19 illustrates the tow bar in use to move the transporter relative to the shipping container.

FIG. 20 is an enlarged view of a further example embodiment, showing the end of the rail and the gripper plate of the grappler and ejector assembly prior to engagement with a platform that has been modified with locking latch and a release assembly for the latch.

FIG. 21 is a further enlarged view, showing the locking latch of FIG. 20 in an open position relative to a gripper plate of the grappler and ejector assembly. in a fully open position.

FIG. 22 is a further enlarged view, showing the locking latch of FIG. 20 in a latched closed position relative to a gripper plate of the grappler and ejector assembly.

FIG. 23 illustrates internal structure of a release assembly associated with the locking latch.

FIG. 24 is an exploded perspective view of a caster assembly according to an example implementation.

Similar reference numbers may be used throughout the drawings for similar components.

### DETAILED DESCRIPTION

In the following detailed description, various details are set forth to provide an understanding of example embodiments of the present disclosure. Yet, the disclosed embodiments are illustrative and not limiting, and the disclosed subject matter is not limited to the particular structures, arrangements, acts, or sequences expressly shown or described. In some embodiments, certain features or elements can be omitted, substituted, combined, reordered, or otherwise modified, and features described in connection with one embodiment can be used in other embodiments unless incompatible therewith. The detailed description and drawings are to be regarded in an illustrative rather than a restrictive sense, and the disclosed subject matter includes rearrangements, modifications, and combinations that fall within the scope of the appended claims.

As used herein, the term “transporter” refers to a structure configured to carry cargo and to move relative to a shipping container and a floor, the transporter comprising a platform and, in some embodiments, one or more components that support, guide, couple, or otherwise facilitate movement of the platform into, out of, or relative to the shipping container.

As used herein, “platform” refers to a structure of the transporter configured to support cargo, directly or indirectly, and may include one or more decks, panels, frames, sheets, members, or other load-bearing components arranged to provide a load-supporting surface and to cooperate with the plurality of casters for movement relative to the shipping container and the floor.

As used herein, “caster” refers to a wheel-supported or rolling support member mounted to the platform and configured to support at least a portion of the transporter for movement relative to another surface, and may include a wheel, wheel assembly, bracket, mount, pivot structure, swivel structure, axle structure, or other associated support components.

As used herein, “floor” refers to any generally supporting surface capable of supporting the transporter for movement relative to the shipping container, including but not limited to a ground surface, pavement, concrete, asphalt, warehouse flooring, a loading dock surface, a trailer bed, or another structural support surface.

As used herein, “shipping container” refers to any structure configured to receive, contain, store, or transport cargo and having an interior space accessible through an opening through which the transporter may move, including but not limited to an intermodal container, freight container, cargo box, storage container, or other cargo-receiving enclosure.

Conventional loading and unloading of cargo relative to a shipping container can be cumbersome because the geometry of the opening, the enclosed nature of the cargo space, and the weight and size of the cargo can make movement into and out of the container difficult, time-consuming, or dependent upon external lifting or handling equipment. In some situations, these constraints can also limit how cargo is positioned, introduced into the container, or retrieved from the container, including limiting the ability to conveniently move cargo relative to the container from different directions while maintaining effective support for the cargo.

To address these issues, the present disclosure provides a transporter having a platform with a load-supporting surface and a plurality of casters mounted for movement between retracted positions and extended positions, wherein the casters automatically transition responsive to traversing the opening of the shipping container. In some embodiments, when the transporter is moved into the shipping container, interaction with the interior horizontal surface can release the casters and urge them toward the retracted positions so the platform can be received within the container. In some embodiments, when the transporter is moved out of the shipping container, one or more actuators, such as springs, can bias the casters toward the extended positions so the platform becomes supported for rolling movement on the floor outside the shipping container while the load-supporting surface remains at a substantially constant elevation relative to the floor. In this manner, cargo can be loaded, unloaded, and repositioned with reduced reliance on separate lifting equipment, and the transporter can, in some implementations, cooperate with powered ejector, grappler, or tow arrangements to facilitate movement relative to the shipping container.

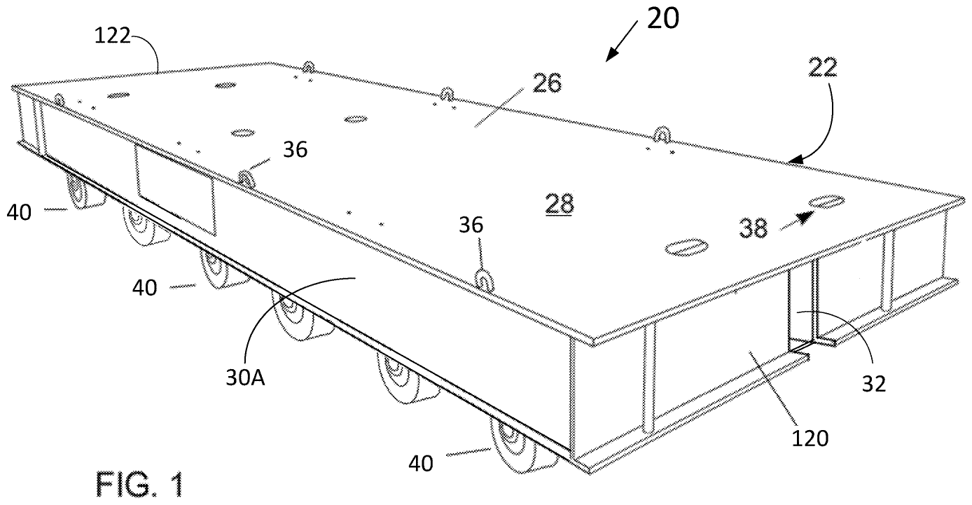

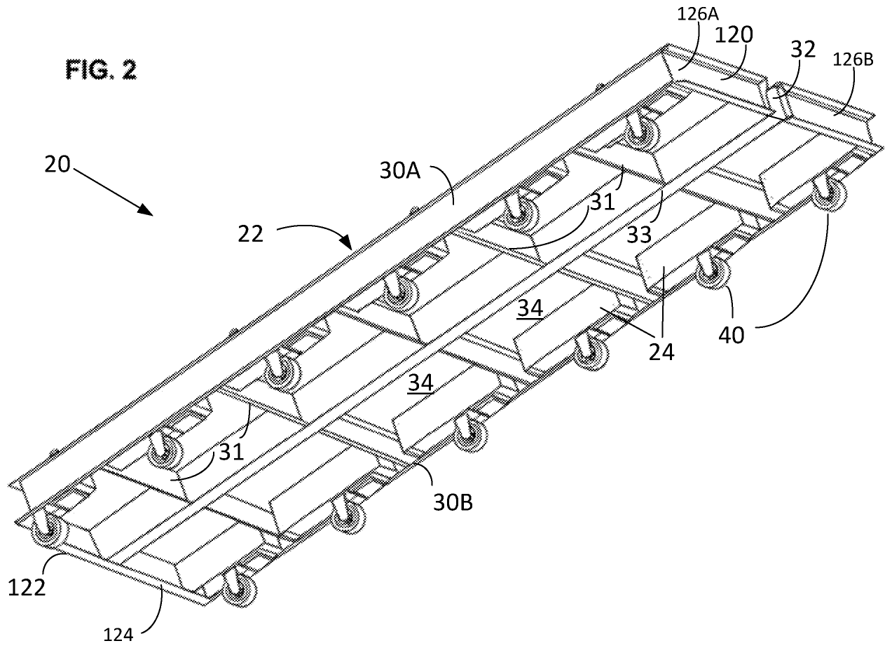

FIGS. 1 and 2 are schematic illustrations showing a transporter 20 according to an example embodiment. The transporter 20 includes a platform 22 and a plurality of caster assemblies 24 that each include a respective castor 40. In the illustrated embodiment, the platform 22 provides a load-supporting structure of the transporter 20, and the plurality of casters 24 are mounted to the platform 22 for movement between retracted positions and extended positions, as described further below. FIG. 1 generally illustrates an upper portion of the transporter 20, whereas FIG. 2 generally illustrates an underside portion of the transporter 20.

In the illustrated example, the platform 22 includes a steel sheet 26 defining a surface 28. In some embodiments, the surface 28 can define the load-supporting surface of the platform 22 for receiving cargo. The platform 22 is shown as having a generally rectangular configuration that extends from a first end 120 to a second end 122, but other configurations are possible provided that the platform 22 remains suitable to support cargo for movement relative to a shipping container and a floor. A plurality of lugs 36 and tie-offs 38 are provided on the steel sheet 26. In some embodiments, the lugs 36 and the tie-offs 38 may facilitate positioning, retaining, securing, or handling cargo carried by the platform 22.

The platform 22 further comprises a plurality of steel members supporting the steel sheet 26. As shown in FIG. 2, these steel members can include a pair of outer sidewall steel members 30A, 30B and a central hollow tube steel member 33 that each extend from the first end 120 to the second end 122 of platform 22. The steel members can also include cross-members 31 that interconnect each of the outer sidewall steel members 30A, 30B respectively to the central hollow tube steel member 33. The first end 120 of platform 22 can include a first steel member 126A that connects a first end of sidewall steel member 30A to one side of a first end of the central hollow tube steel member 33, and a second steel member 126B that connects a first end of sidewall steel member 30B to the other side of the first end of the central hollow tube steel member 33. The second end 122 of platform 120 can include a steel member 124 that interconnects with the second ends of the pair of outer sidewall steel members 30A, 30B and the second seconds end of central hollow tube steel member 33. The steel members 30A, 30B, 31, 33, 124, 126A, 126B are secured together by welded joints and/or mechanical fasteners to collectively form a grid structure for supporting the steel plate 26, and define a central elongate slot or channel 32 that extends from the first end 120 to the back end 122 of the platform 22. The channel 32 is open at the first end 32 for receiving a rail. In the illustrated example, the elongate channel 32 is defined by an interior of the central hollow tube steel member 33, which may for example be implemented using a length of Rectangular Hollow Section (RHS).

The grid structure provided by the steel members defines a plurality of internal, downwardly opening spaces or pockets 34. In the illustrated embodiment, a respective caster assembly 24 is provided for each pocket 34 such that the plurality of casters 40 are distributed about the platform 22. Each caster 40 is mounted to the platform 22 within its respective pocket 24 by its respective caster assembly 24.

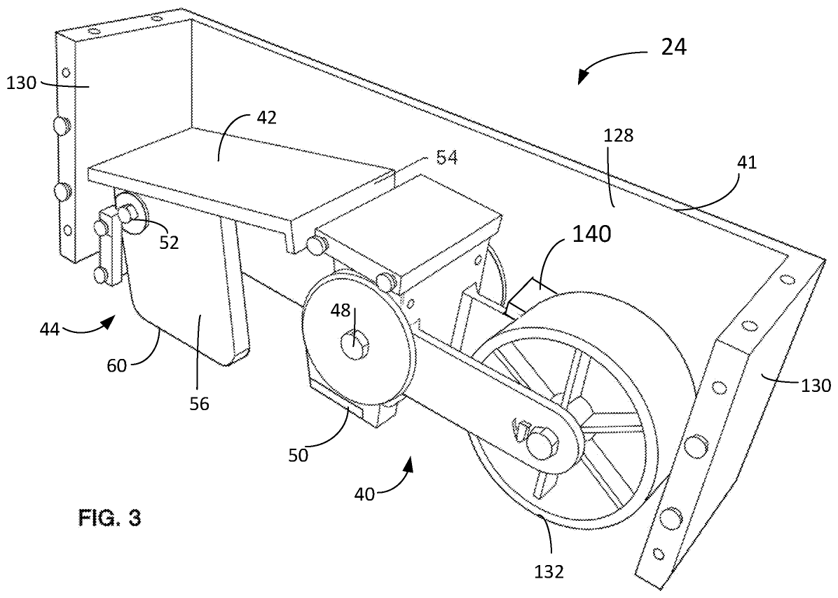

FIGS. 3 to 6 are schematic perspective views showing details of a caster assembly 24 according to an example embodiment. In the illustrated embodiment, a respective caster assembly 24 comprises a caster 40 and a caster locking assembly 44 that are housed within a castor assembly housing 41. The caster 40 is mounted to the platform 22 via a pin 48 for pivoting movement about pin 48 between a retracted position and an extended position. More particularly, in the illustrated example, the caster 40 is mounted by pin 48 to the castor assembly housing 41 which in turn is secured to platform 22.

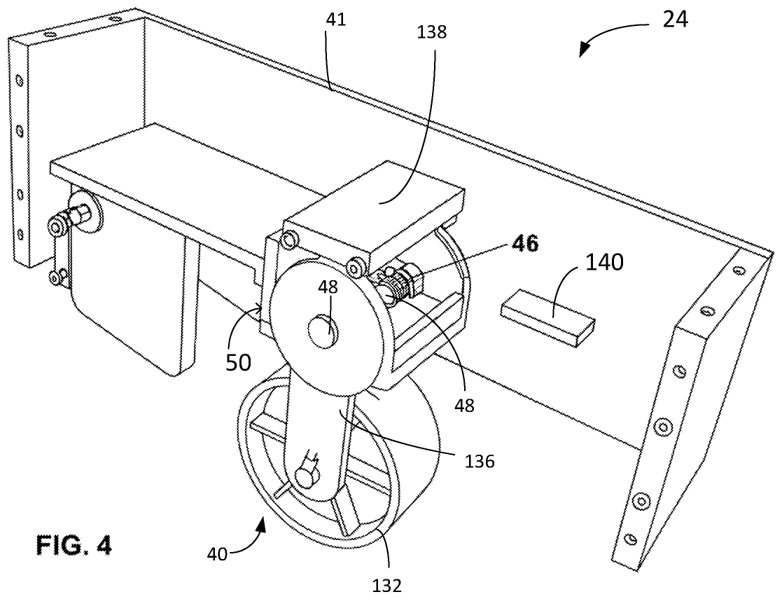

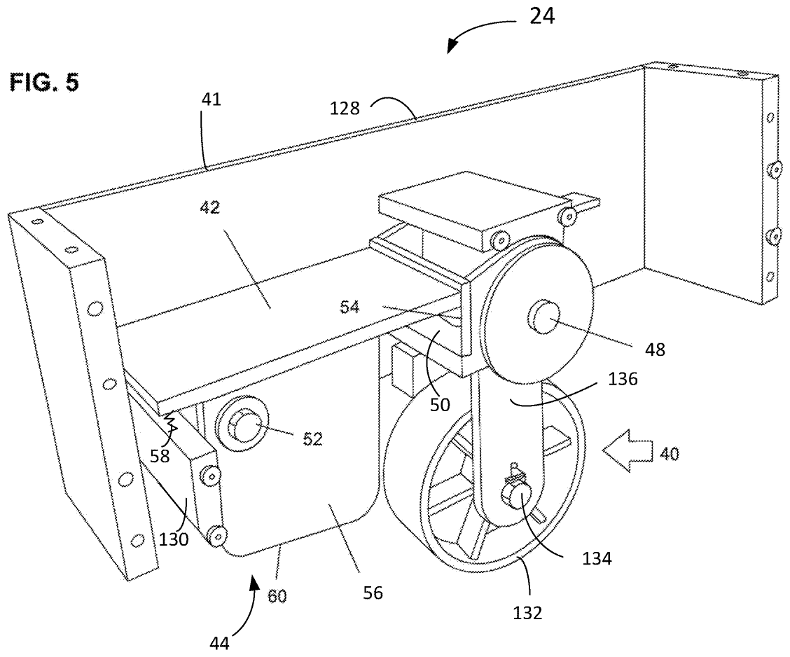

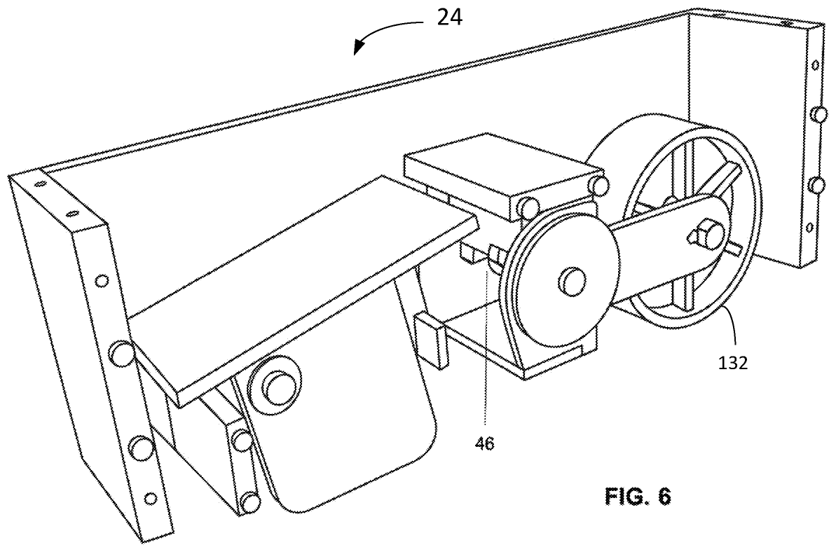

FIGS. 3 and 6 show caster assembly 24 with castor 40 in a retracted position. FIGS. 4 and 5 show caster assembly 24 with the caster 40 locked in an extended position.

In the illustrated example, caster assembly housing 41 is a rectangular steel box structure secured to one or more of the steel members that define the pocket 34 that the caster assembly 24 is positioned within. The castor assembly housing 41 can include a pair of opposed sidewalls 128 that are interconnected by cross members 130. Only one of the opposed sidewalls is shown in each of FIGS. 3 to 6 in order to facilitate a view of the interior of the caster assembly housing 41.

The caster locking assembly 44 includes a locking plate 42 that engages the caster 40 to lock the caster 40 into an extended position. The caster locking assembly 44 also includes a trigger. The caster locking assembly 44, including locking plate 42 is mounted to the platform 22 via a pin or shaft 52. In particular, in the illustrated example, the caster locking assembly 44 is mounted by pin 52 to the caster assembly housing 41 to pivot between a locking position (shown in FIGS. 4 and 5) and a release position (shown in FIGS. 3 and 6). Locking plate 42 defines an arresting surface 54. The trigger of caster locking assembly 44 comprises a trigger plate 56 and a bias spring 58, and the plate 56 terminates in a camming surface 60. The trigger plate 56 can be actuated for releasing the caster 40 to enable it to move to the retracted position.

As best seen in FIG. 5 in the illustrated example the caster 40 can be an assembly or rig that includes a caster wheel 132 rotatably mounted by an axle pin 134 to a yoke 136. The yoke 136 of caster 40 can define an abutment surface 50 for interacting with an arresting surface 54 of the locking plate 42.

In the illustrated embodiment, as best seen in FIG. 4, the caster assembly 24 includes an actuator 46 for moving the caster 40 to its extended position. The actuator 46 can, for example, include an actuator spring such as a coil spring that is wound around caster mounting pin 48, with a first end engaging the caster yoke 136 and a second end engaging a support member 138 of the caster assembly housing 4, the actuator spring being configured to bias the caster 40 toward the extended position.

As seen in FIG. 4, one or more caster stop members 140 can be secured to the caster assembly housing 41. Caster stop member 140 is configured to cooperate with caster 40 to define a maximum retraction position for the caster 40 such that a bottom portion of the caster wheel 132 will protrude far enough beneath the platform 22 to provide rolling support for the platform. By way of example, FIG. 3 shows a portion of a caster stop member 140 engaging an upper side of one of the legs of caster yolk 136, preventing further upward rotation of the caster, thereby defining a maximum retraction limit of the caster 40 when it is in its retracted position. The caster stop member 140 also functions as a load support structure as it bears some of the load that is supported by the caster 40 when in the retracted position.

FIGS. 3 and 6 illustrate the caster assembly 24 in a released condition in which the locking plate 42 is in a release position and the caster 40 is in the retracted position. In this condition, the caster 40 is movable relative to the platform 22 between the retracted position and the extended position. FIGS. 4 and 5 illustrate the caster assembly 24 in an extended condition in which the caster 40 has traversed to the extended position and the locking plate 42 is in a locking position. In the locking position, the arresting surface 54 bears against the abutment surface 50 to releasably lock the caster 40 against pivoting movement. In this manner, in some embodiments, a respective caster 40 releasably locks upon movement to the extended position.

The trigger plate 44 and the actuator 46 cooperate to permit automatic transition of the caster 40 between the retracted position and the extended position. In some embodiments, pressure applied to the camming surface 60 causes the locking plate 42 to move to the release position, thereby permitting the caster 40 to be urged toward the retracted position against the bias of the actuator 46. In some embodiments, when the releasing force is removed, the actuator 46 moves the caster 40 toward the extended position, and the bias spring 58 returns the locking plate 42 toward the locking position so that the arresting surface 54 can again engage the abutment surface 50. Accordingly, the illustrated caster assembly 24 provides one example of a mechanism by which a respective caster 40 can be urged by an interior horizontal surface to the retracted position, can be moved to the extended position by an actuator 46, and can releasably lock when in the extended position.

It will be apparent from FIGS. 3-6 that the wheel of 132 of caster 40 is located at a greater distance below the platform when caster 40 is in the extended position relative to the retracted position. In example

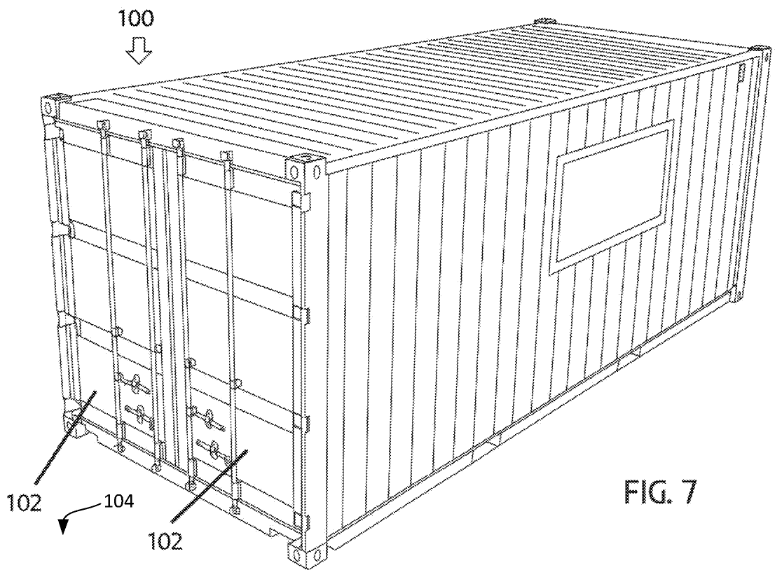

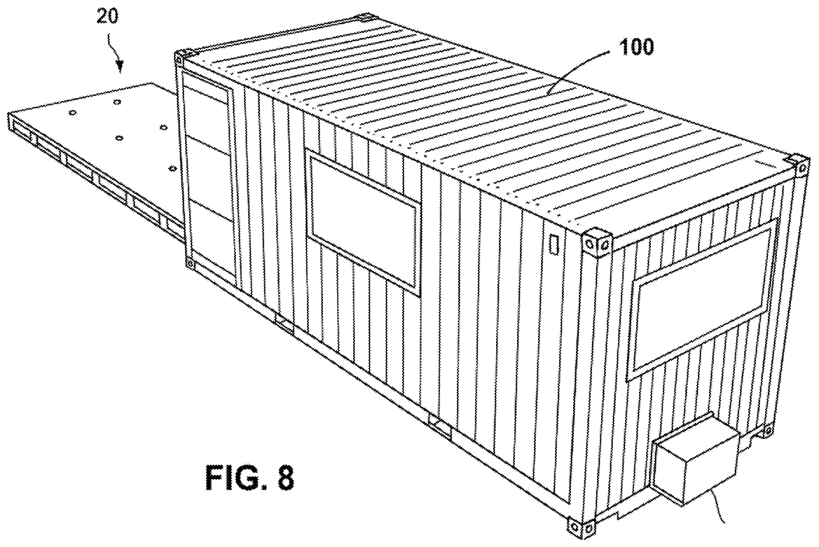

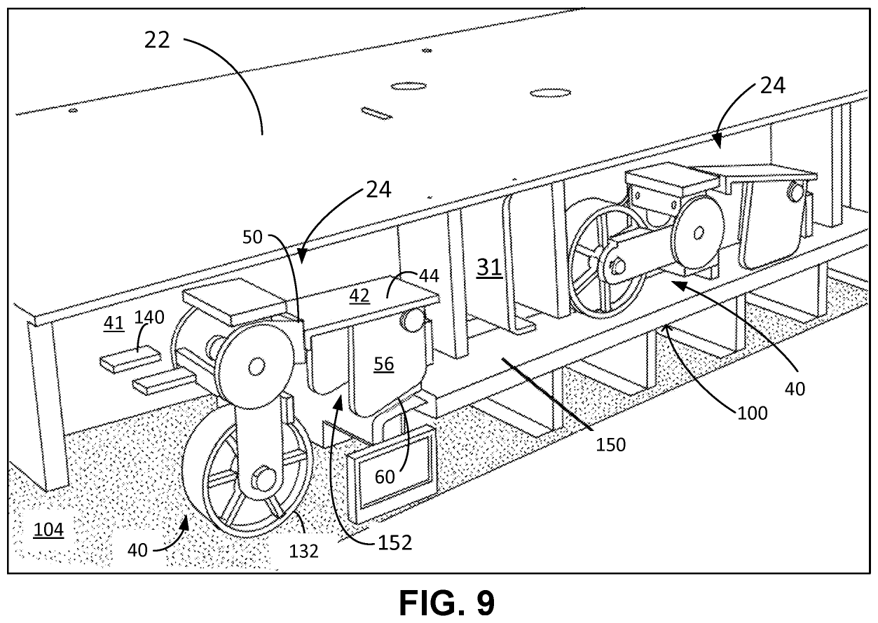

FIGS. 7 to 11 illustrate example interaction between the transporter 20 and a shipping container 100 during loading and unloading operations. FIG. 7 shows the shipping container 100, which in the illustrated embodiment includes rear doors 102 providing access to an interior cargo space through an opening. FIG. 8 shows the transporter 20 positioned relative to the container 100 for movement through the opening. FIG. 9 illustrates the platform 22 and the caster assemblies 24 relative to a floor 104 outside the container.

In some embodiments, the transporter 20 is configured so that the caster assemblies 24 automatically transition between retracted positions and extended positions responsive to traversing the opening of the container 100. When the transporter 20 is moved into the container 100 from the floor 104, the caster assemblies 24 can encounter the interior horizontal surface of the container 100 as the caster assemblies 24 reach the container. As discussed above with respect to the trigger and locking arrangement, such interaction can release the caster assemblies 24 for movement toward the retracted positions. In some embodiments, continued movement of the transporter 20 into the container 100 urges the caster assemblies 24 toward the retracted positions so that the platform 22 can be received within the container 100.

When the transporter 20 is moved out of the container 100, the reverse transition can occur automatically. More particularly, the caster assemblies 24 can commence in the retracted positions while the transporter 20 is within the container 100 and, as the caster assemblies 24 traverse the opening and exit the container 100, the releasing force applied by the interior horizontal surface is removed. In some embodiments, one or more actuators, such as the actuator 46 described above, then move the caster assemblies 24 toward the extended positions so that the platform 22 becomes supported for rolling movement on the floor 104 outside the container 100. In embodiments employing the locking plate 42 and abutment surface 50 arrangement described above, the caster assemblies 24 may releasably lock upon reaching the extended positions.

In some embodiments, the transporter 20 is configured such that the load-supporting surface of the platform 22 remains at a substantially constant elevation relative to the external floor 104 as the transporter 20 exits the container 100. Thus, the transporter 20 can transition from a condition suitable for movement within the container 100 to a condition suitable for rolling movement on the floor 104 outside the container 100 without requiring separate lifting of the cargo from the platform 22.

The shipping container 100 comprises a container floor 150 that defines an interior horizontal surface for supporting the transporter 20 and cargo carried thereby while the transporter 20 is disposed within the container 100. The transporter 20 comprises the platform 22 and the plurality of caster assemblies 24, and the transporter 20 is configured to move through the opening between a position inside the container 100 and a position outside the container 100 on the floor 104.

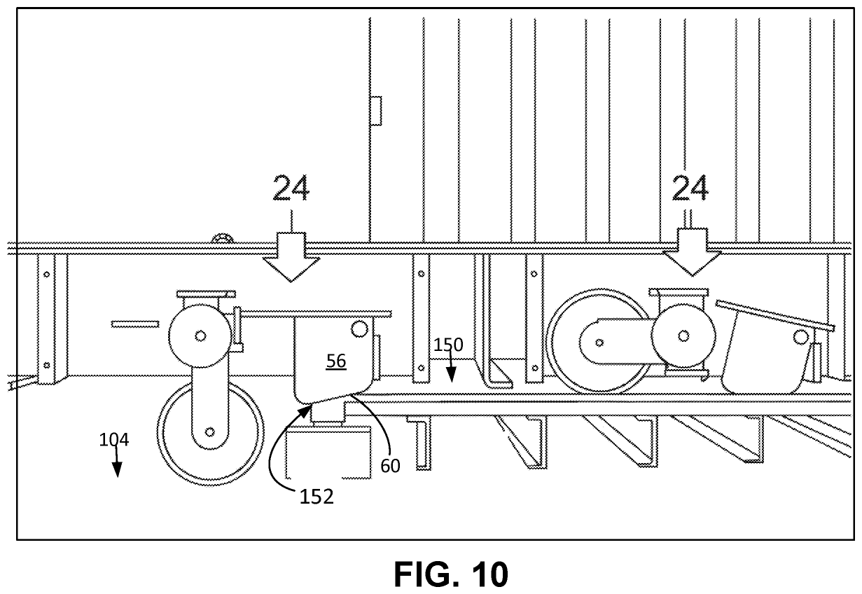

FIG. 7 generally illustrates the shipping container 100 as a structure suitable for use with the disclosed transporter 20. FIG. 8 illustrates the transporter 20 positioned adjacent the container 100 for movement through the opening of the shipping container 100. FIGS. 9 and 10 are each cut-away partial views illustrating the platform 22 and the plurality of caster assemblies 24 relative to an external floor 104 outside the shipping container and a support surface defined by the internal container floor 150 of the shipping container 100. In FIGS. 9 and 10, platform 22 is partially loaded into container 100, with the right-most caster assembly 24 (and thus its caster 40) being in its retracted position and supporting a respective portion of the platform 22 relative to the internal container floor 150 and the left-most caster assembly 24 (and thus its caster 40) being in its extended position and supporting a respective portion of the platform 22 relative to the external floor 104.

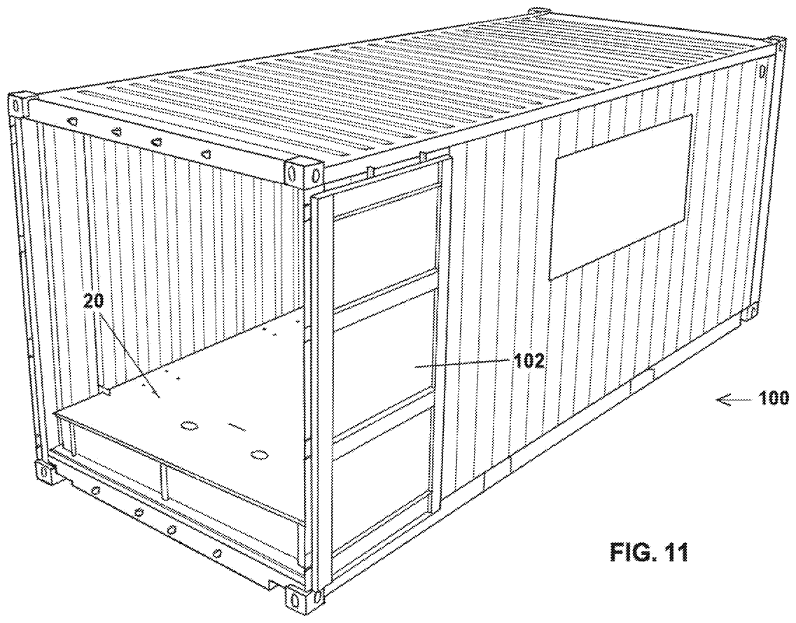

FIG. 11 illustrates the transporter 20 loaded into the shipping container.

In some embodiments, the cargo transport system allows the transporter 20 to support cargo while the transporter 20 is moved into the container 100 for loading or out of the container 100 for unloading. When the transporter 20 is within the container 100, the interior horizontal surface of the container floor 150 can support the transporter 20 in a manner compatible with the caster assemblies 24 being in retracted positions. When the transporter 20 exits the container 100, the caster assemblies 24 can move to extended positions so that the platform 22 is supported for rolling movement on the floor 104 outside the container 100. Accordingly, the shipping container 100 and the transporter 20 together define a cargo transport system that facilitates movement of cargo through the container opening while maintaining support for the platform 22 and the cargo carried thereon.

More particularly, as the platform 22 moves into the container 100, when a caster assembly 24 approaches an edge transition 152 of container floor 150, the edge transition 152 interacts with the camming surface 60 of the trigger plate 56, overcoming the bias force of locking plate bias spring 58 to move the locking plate 42 into its release position. The edge transition 152 then interacts with caster wheel 132 to pivot the caster 40 into its retracted position until it engages caster stop member 140. As shown in the Figure, the locking plate 42 is maintained in its release position when inside trailer 100 by interaction of the camming surface 60 with container floor 150. Similarly, the caster 40 remains in its retracted position. In the opposite direction, when the platform 22 moves out of the container 100, once caster wheel 132 passes out over the edge transition 152, the spring of caster actuator 46 forces the caster 40 into its extended position so caster wheel 132 will engage external floor 104. Similarly, as the camming surface 60 of the trigger plate 56 passes out over the edge transition 152, the locking plate bias spring 58 pushes the locking plate 42 into its locking position to engage the abutment surface 50 of caster 40 and lock the caster 40 into its extended position.

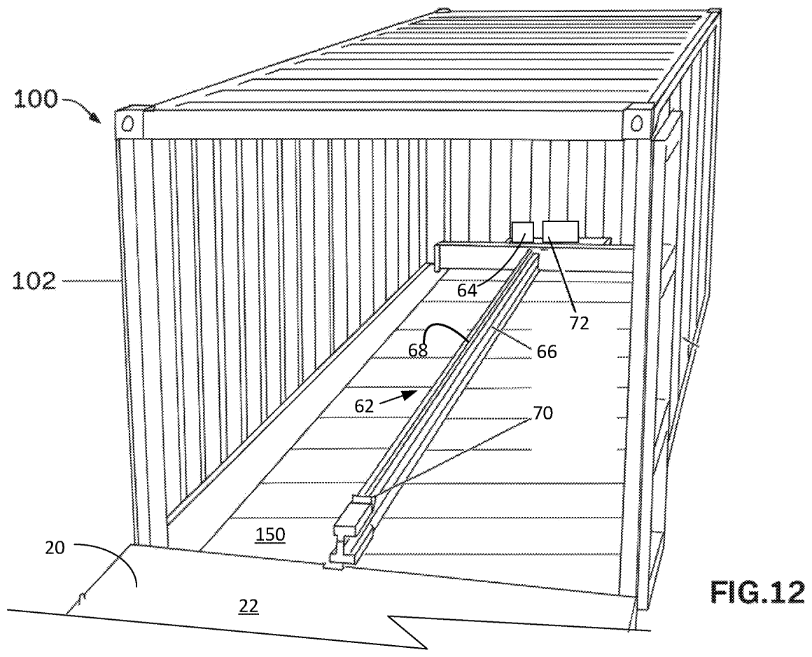

FIGS. 12 to 16 illustrate example embodiments of powered handling components that can be used as part of a cargo transport system with the transporter 20 and the shipping container 100 to facilitate movement of the transporter 20 relative to the container 100. In example embodiments, these powered handling components are mounted within the shipping container 100, and include an ejector assembly 62 configured to expel the transporter 20 from the shipping container 100 and, in some embodiments, a grappler 64 configured to draw the transporter 20 into the shipping container 100.

FIG. 12 illustrates an example of an ejector 62 and grappler 64. In the illustrated embodiment, the ejector 62 is an arrangement of components that includes a central rail 66, chain loop 68 (also referred to herein as a belt loop), a gripper plate 70, and a motor 72. In the illustrated example, central rail 66 extends adjacent the container floor 150 from the opening end of the shipping container 100 to an interior end of the shipping container 100. Central rail 66 supports and guides the gripper plate 70 and chain loop 68. The chain loop 68 is operatively mounted to the shipping container 100, and the gripper plate 70 is operatively mounted to the chain loop 68 for movement therewith. The motor 66 is operatively mounted to drive the chain loop 68 so that the gripper plate 70 can be selectively advanced relative to the container 100.

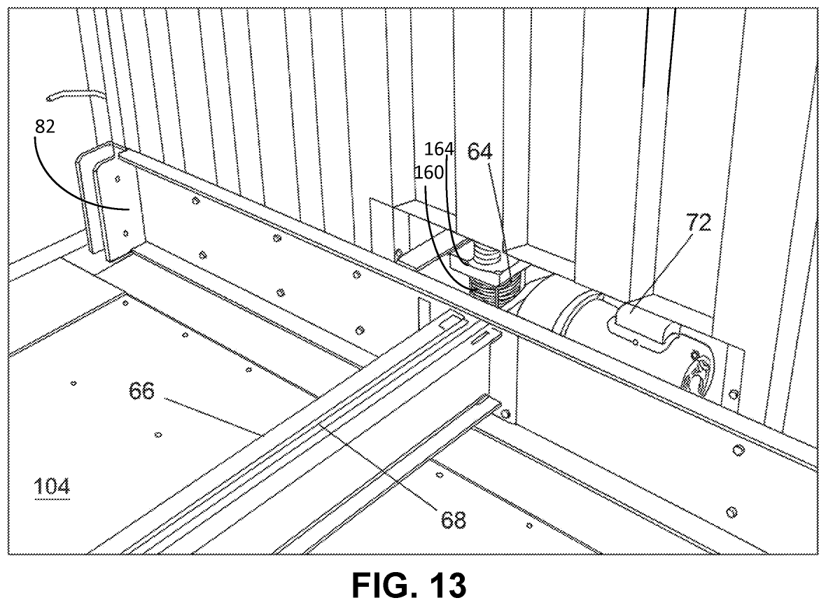

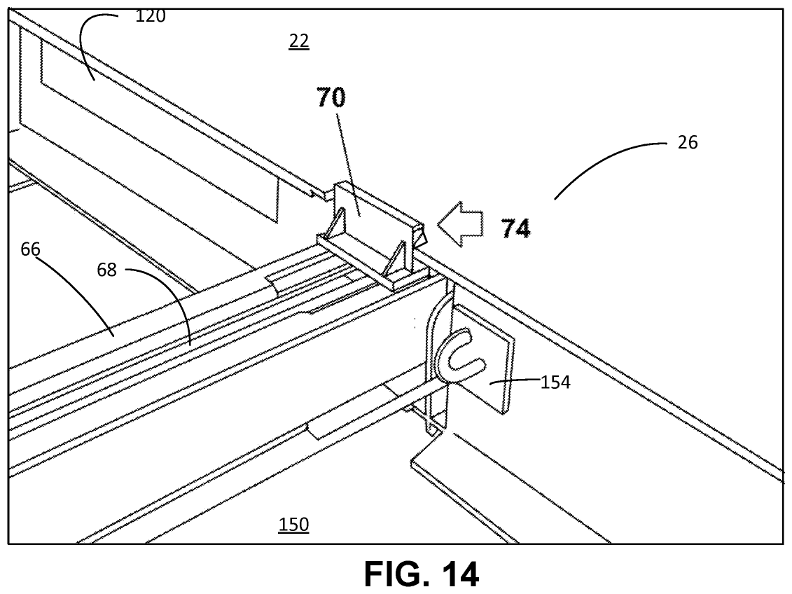

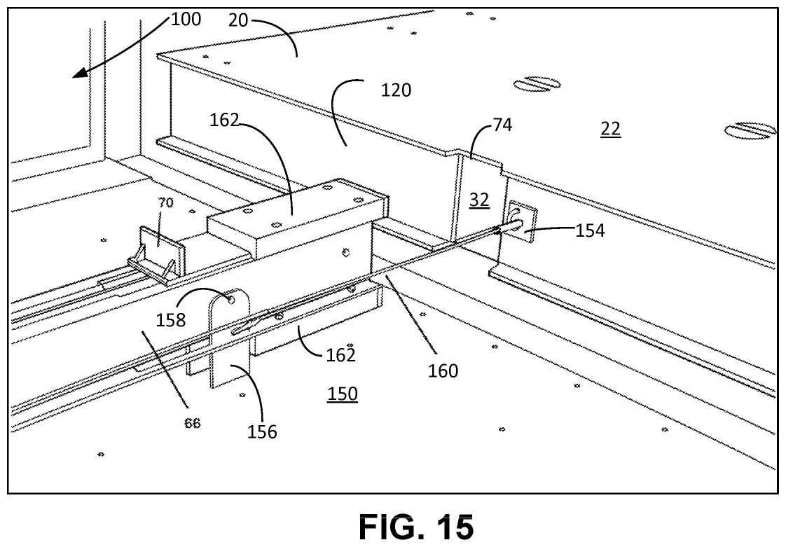

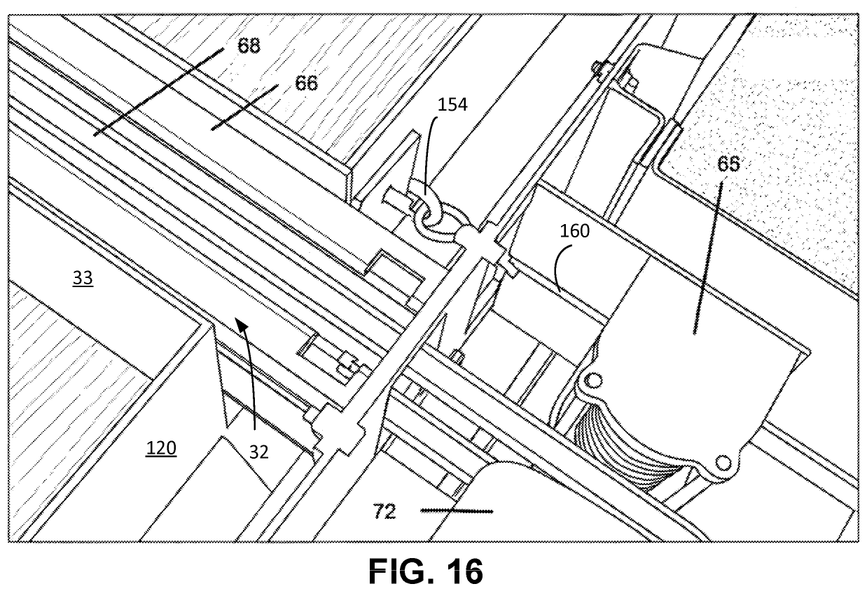

FIG. 13 is an enlarged view showing the grappler 64 and a portion of the ejector 62 in greater detail. In the illustrated example, grappler 64 includes a winch 164 equipped with a grappling cable 160 located at the interior end of the container 200. FIG. 14 is an enlarged view showing an extending end of central rail 66 and gripper plate 70 of the ejector 62 in engagement with the platform 22. FIG. 15 is a further enlarged view showing the extending end of the central rail 66 and the gripper plate prior to engagement with the platform of FIG. 1. FIG. 16 is a further enlarged view showing a cut-away portion of the platform and the central rail when the platform is loaded into the shipping container.

With reference to FIG. 15, grappler 64 can function as follows to draw the transporter 20 into the shipping container 100: (i) an end of the grappling cable 160 can be secured to a grappling cable anchor 154, for example a hook, that is secured to the front end 120 of the transporter platform 22. The grappler winch 164 can then be activated to advance the transporter 20 into the shipping container 100. In embodiments that include ejector 62, the central rail 66 is configured to be received within the central channel 32 of the platform 22 as the platform 22 is drawn into the container 100. In some examples, the end of the central rail 66 that is adjacent the container opening includes one or more guide blocks 162 that are dimensioned to guide and support the central rail 66 within the central channel 32. In one example, the central rail 66 includes one or more pivoting rail support legs 156 that support the central rail 66 relative to container floor 150 when the central rail is not received within central channel 32. The rail support legs 156 can for example be spring biased into a support position such as shown in FIG. 15 wherein the rail support legs 154 rest on container floor 150 to support the central rail 66 in spaced apart alignment with the container floor 150 at a suitable height for the central rail 66 to align with the central channel 32 of a platform 22 that is being loaded into container 100. As the central rail 66 is received further and further within the central channel 32, the rail support legs 156 are contacted by the lower wall edge that defines the central channel 32 and pivoted about respective mounting pins 158 into a retracted position alongside the sides of the central rail 66 such that the rail support legs 156 can be received within the central channel 32. When the platform 22 is ejected in the reverse direction, the rail support legs 156 are spring (or weight) biased to pivot back down to a support position as they exit the central channel 32. FIG. 16 shows a cut-away view of platform 22 showing the interior of central channel 32 with the central rail 66 positioned in the channel, In FIG. 16 the platform 22 is drawn completely into the interior of the container 100.

With regard to the operation of ejector 62, as best seen in FIG. 14, the gripper plate 70 can be configured to be received within a locater notch 74 that is defined by steel plate 26 at a location above the central channel 32. Chain loop 68 can be driven by motor 72 to cause the gripper plate 70 to push against the steel plate 26 of platform 22 to push the platform 20 out of the shipping container 100.

Thus, ejector 62 and grappler 64 can cooperate with the transporter 20 to effect movement of the transporter into and out of the shipping container 100. The grappler 64, using its winch arrangement operatively coupled to the transporter 20, can be operated to so that the transporter 20 can be pulled inwardly through the opening of the container 100. The ejector 62 can provide powered expulsion of the transporter 20 from the shipping container 100. These components may be used separately or together to facilitate controlled loading and unloading operations.

Referring to FIG. 8, in some examples, the motor 72 and winch 164 are located in, or extend into a motor enclosure 170 that is located external to the cargo holding interior of container 100. In some examples, motor 72, winch 164 and motor enclosure 170 are removable and a flat panel can be secured to the container 100 in place of motor enclosure 170 to seal the opening. In some use applications, this can be done for ease of shipment and to avoid damage in shipment.

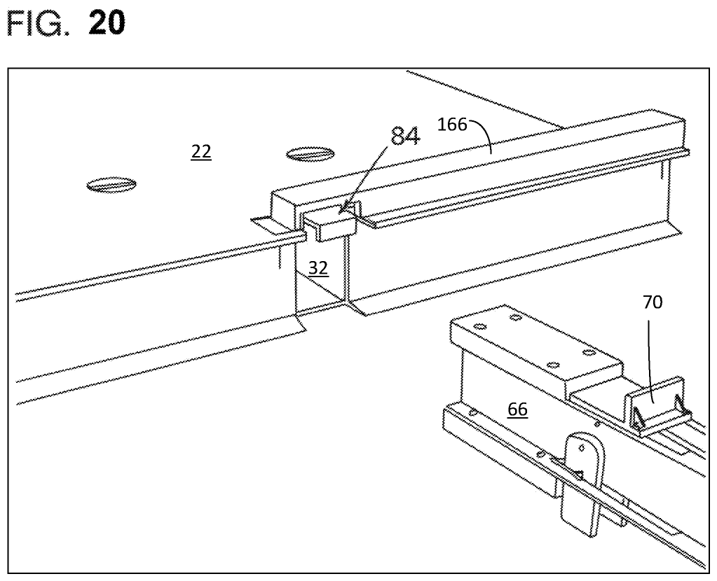

FIGS. 20 to 23 illustrate a further embodiment in which the platform 22 carries a latch 84 configured to releasably engage the gripper plate 70 so as to permit movement of the platform 22 with the gripper plate 70 in both directions. In some embodiments, this arrangement can be used in connection with the ejector 62 arrangement described above so that the same gripper plate 70 can be used not only to urge the platform 22 outwardly from the shipping container 100, but also to pull the platform 22 inwardly relative to the shipping container 100.

FIG. 20 illustrates the platform 22 in operative relation to the shipping container 100, with the central channel 32 aligned with the outer end of central rail 66. Latch 84 is pivotally mounted to platform 22 so that it can engage the gripper plate 70 once the outer end of central rail 66 is received within the central channel 32. The latch 84 is operably connect to a latch actuation assembly that allows the latch 84 to be moved between a latched position and an unlatched position. The latch actuation assembly is located under a protective cover 166 in FIG. 20.

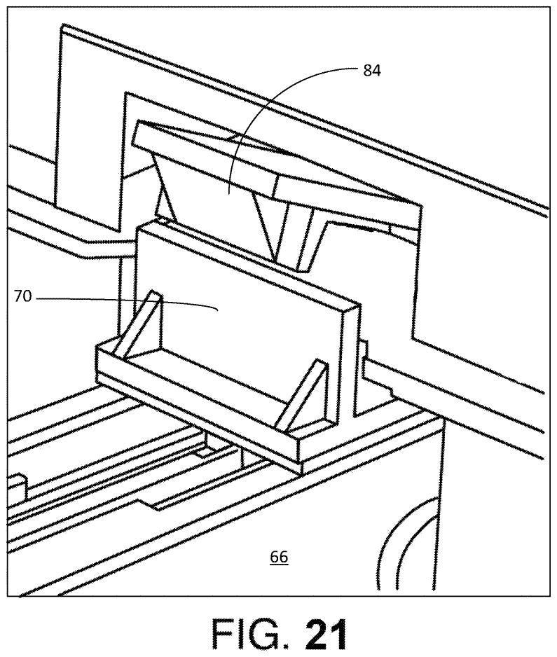

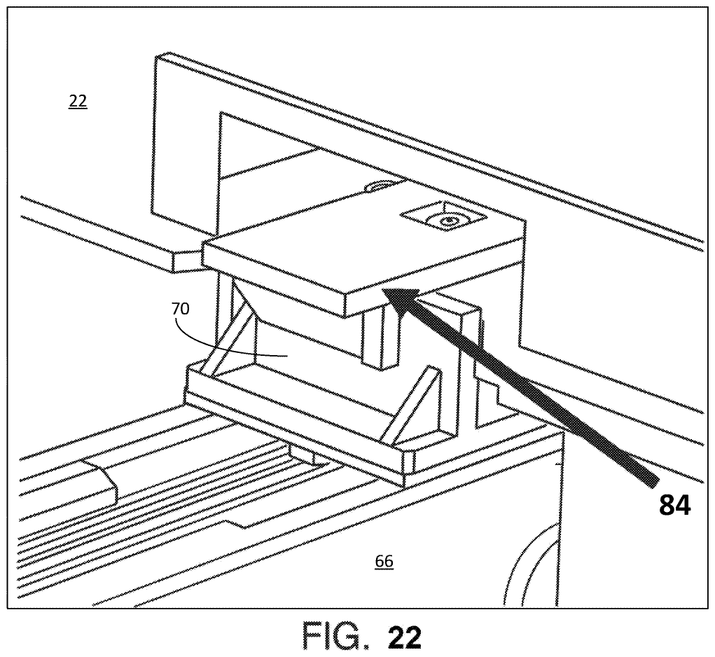

FIG. 21 is an enlarged view showing the latch 84 in a fully open (i.e. unlatched) position to permit passage of the gripper plate, and FIG. 22 shows the latch 84 in a latched position whereby the latch 84 is in locking receipt of the gripper plate 70 so that the platform 22 can be drawn inward into the container 100 by the gripper plate 70. In this manner, the latch 84 can selectively engage the gripper plate 70 to enable the gripper plate 70 to provide bidirectional movement of the platform 22 under force of the chain loop 68. In this configuration, ejector 62 also functions as grappler.

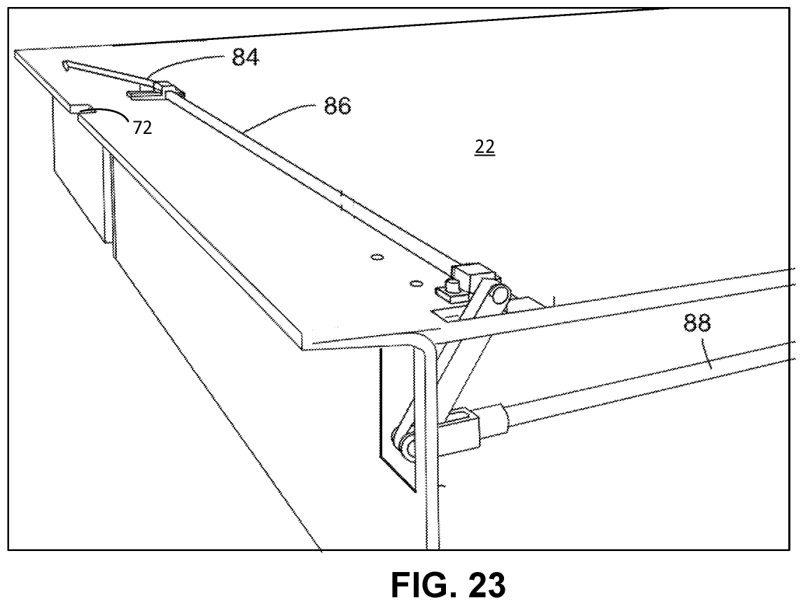

FIG. 23 further illustrates internal structure associated with the latch 84 with cover 166 removed. In the illustrated embodiment, the latch 84 is carried by a rotatably mounted locking bar 86, and the locking bar 86 is actuated by a reciprocating arm 88. In some embodiments, the reciprocating arm 88 can be driven by an actuator such as a solenoid, a stepper motor, a manual lever, or another suitable mechanism. Accordingly, the latch 84 may be selectively transitioned between an open condition and an engaged condition depending upon whether engagement with the gripper plate is desired.

In some embodiments, the latch 84 provides a releasable coupling feature carried by the platform 22 that can cooperate with the ejector structure to expand the available handling modes of the cargo transport system. For example, when the latch 84 is engaged with the gripper plate, powered movement of the gripper plate can be transmitted to the platform 22 in either direction. When the latch 84 is disengaged, the platform 22 can instead be moved independently, including by manual handling, by a grappler, or by other transport arrangements described elsewhere in the present disclosure. Thus, the latch 84 can provide a selectively engagable interface that enhances flexibility in loading and unloading cargo relative to the shipping container 100.

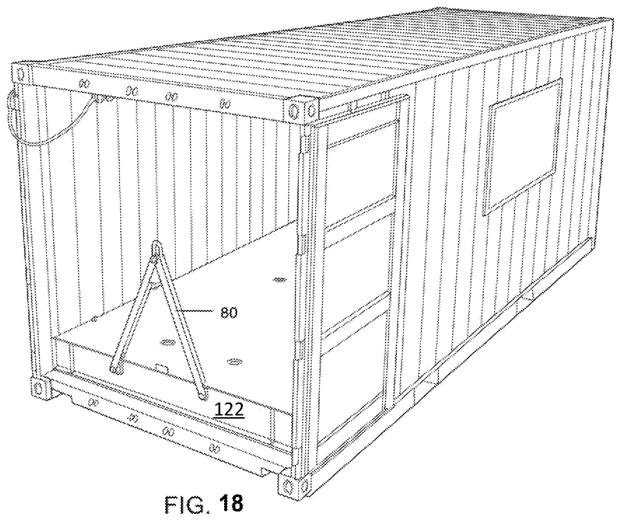

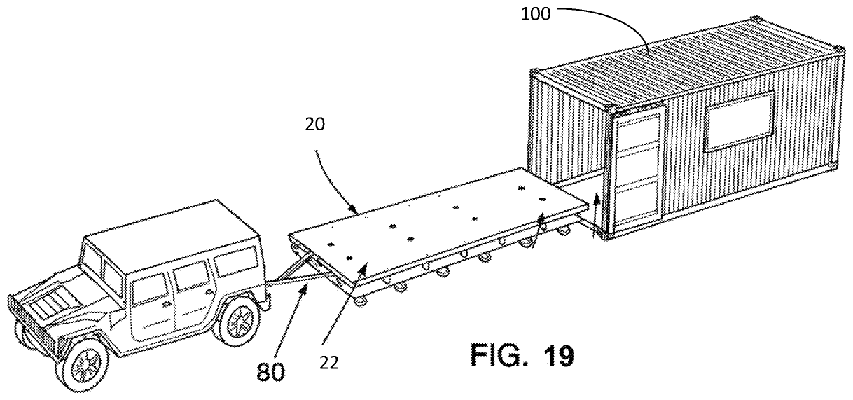

FIGS. 18 and 19 illustrate further mobility-related embodiments that can be used with the transporter 20. These embodiments may be employed alone or in combination with the ejector, grappler, and latch arrangements described elsewhere in the present disclosure to facilitate movement of transporter 20 relative to the shipping container 100.

FIG. 18 illustrates an embodiment including that includes a tow structure. In some embodiments, the tow structure comprises a tow bar 80 pivotably mounted to the second end 122 of platform 22. The tow bar 80 can provide a connection point for a towing vehicle, manual pulling arrangement, or other motive source used to move the transporter 20 relative to the shipping container 100. FIG. 19 illustrates the tow bar 80 being used to move the transporter 20 relative to shipping container 100.

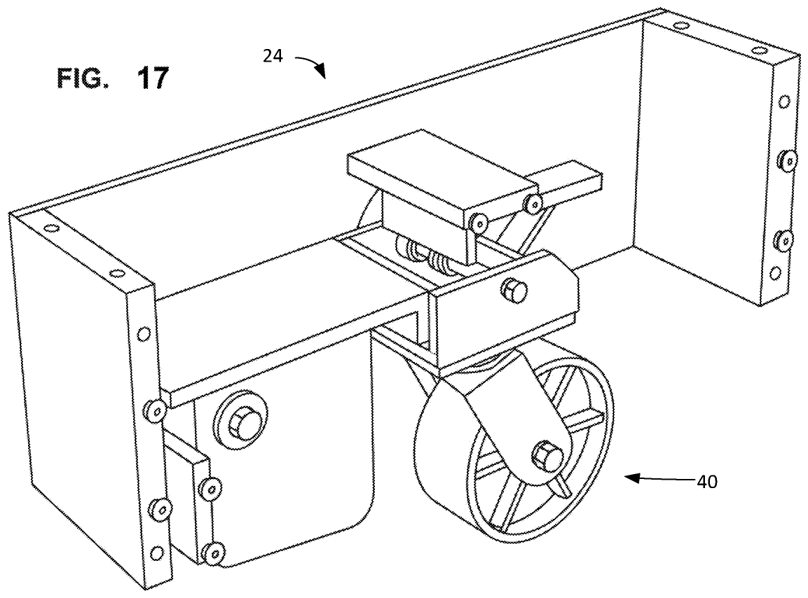

In some embodiments, the plurality of casters 40 of the transporter 20 can comprise swivel casters. Use of swivel casters can permit improved maneuverability of the transporter 20 on the floor 104 outside the shipping container 100, including when the transporter 20 is being manually positioned, towed, or otherwise redirected after exiting the container 100. In some embodiments, swivel capability can be provided for all casters or only for selected casters, depending on the desired handling characteristics. In this regard, FIG. 17 illustrates a version of caster assembly 24 wherein the caster 40 is a swivel caster.

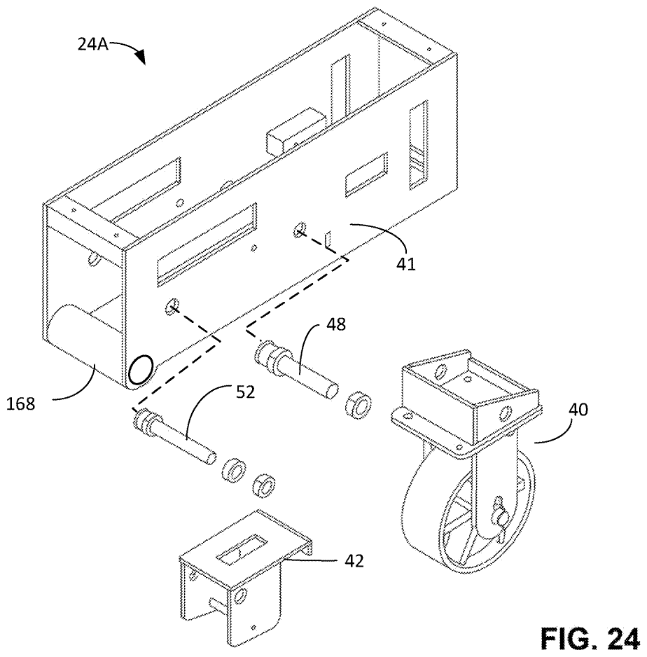

FIG. 24 illustrates an exploded view of an example caster assembly 24A that can be used with platform 22 and is similar to caster assembly 24 described above. However, the caster assembly 24A includes a roller 168 that is rotationally mounted to the caster assembly housing 41. The roller 168 is configured to engage the container floor 150 and transition edge 150 during the time that the caster 40 is transitioning between its extended position and its retracted position to provide rolling support for respective portion of the weight of platform 22 during that transition period. As described above, caster assembly 24 is configured, in at least some examples, such that caster wheel 132 is in rolling load supporting contact with external floor 104 when in an extended position and with container floor 150 when in the retracted position. The additional presence of roller 168 enables rolling support to also be provided by the caster assembly 24A even while the caster 40 is moving between its extended and retracted positions.

The Figures illustrate example methods of moving cargo relative to the shipping container 100 using the transporter 20. In some embodiments, the method begins by disposing the transporter 20 adjacent the opening of the shipping container 100, with cargo carried on the platform 22 and with the transporter 20 positioned for movement through the opening relative to the floor 104. In some embodiments, the method comprises causing the transporter 20 to move through the opening into the shipping container 100. As the transporter 20 is advanced inwardly from the floor 104 toward the container 100, the caster assemblies 24 can encounter the interior horizontal surface of the shipping container 100. In embodiments employing the trigger and locking arrangements described above, engagement of the trigger with the interior horizontal surface can release the respective caster assemblies 24 for movement toward the retracted positions. Continued inward movement of the transporter 20 can thereby urge the caster assemblies 24 toward the retracted positions so that the platform 22 and the cargo 110 carried thereon can be received within the shipping container 100.

In some embodiments, the method additionally or alternatively comprises moving the transporter 20 out of the shipping container 100. While the transporter 20 is within the shipping container 100, the caster assemblies 24 can commence in the retracted positions. As the transporter 20 is moved outwardly and the caster assemblies 24 traverse the opening, the releasing force imposed by the interior horizontal surface is removed. One or more actuators, such as springs, can then bias the caster assemblies 24 toward the extended positions so that, upon exiting the shipping container 100, the platform 22 becomes supported for rolling movement on the floor 104 outside the shipping container 100. In some embodiments, the load-supporting surface of the platform 22 remains at a substantially constant elevation relative to the floor 104 during this transition, thereby permitting cargo 110 to be loaded or unloaded without requiring separate lifting of the cargo from the platform 22.

In some embodiments, outward movement of the transporter 20 can be implemented using a powered ejector arrangement. As described above with, a chain loop and associated gripper plate can be driven by a motor to urge the transporter 20 toward and through the opening of the shipping container 100. In some embodiments, the transporter 20 can also cooperate with a central rail and associated engagement features during powered movement relative to the shipping container 100.

In some embodiments, inward movement of the transporter 20 can be implemented using a grappler, such as a cable winch arrangement, to draw the transporter 20 into the shipping container 100. In further embodiments, movement of the transporter 20 relative to the shipping container 100 can be implemented by towing the transporter 20 with a tow bar 80 pivotably mounted to the platform 22.

Accordingly, the disclosed method can be practiced using manual, powered, grappled, or towed implementations while preserving the automatic transition of the caster assemblies 24 responsive to crossing the opening of the shipping container 100. In view of the foregoing, the disclosed transporter 20, cargo transport system, and associated methods can provide a practical approach to loading and unloading cargo relative to a shipping container 100 while maintaining effective support for the cargo throughout the transition between movement inside the container 100 and rolling movement on the floor 104 outside the container 100. By arranging the caster assemblies 24 to automatically transition between retracted positions and extended positions responsive to crossing the opening of the container 100, the transporter 20 can move between a configuration suitable for receipt within the container 100 and a configuration suitable for rolling transport outside the container 100 while not requiring separate lifting of the cargo from the platform 22.

In some embodiments, this arrangement can reduce reliance on pallet lifters or other external lifting equipment and can permit cargo to be loaded, unloaded, repositioned, or retrieved in a more efficient manner. In some embodiments, the transporter 20 can facilitate loading from the rear of the shipping container 100 and, in some implementations, can also permit cargo to be introduced relative to the container 100 from other directions, including by self-loading perpendicular to the opening. Further, because the transporter 20 can be moved manually, by a powered ejector, by a grappler, or by towing arrangements, the disclosed subject matter can provide substantial flexibility for different operational environments and customer preferences.

In some embodiments, the disclosed structural features can also promote reliable operation and adaptability. For example, the trigger, locking plate 42, actuator 46, and optional roller support arrangements can cooperate to support controlled deployment and retraction of the caster assemblies 24, while the ejector, grappler, latch, tow bar, and related handling components can expand the available loading and unloading modes of the cargo transport system. The detailed mechanical arrangements shown and described herein may be implemented in different sizes, load ratings, and geometric configurations, including configurations selected to accommodate different shipping container dimensions, while preserving the functional relationship by which the caster assemblies 24 automatically transition in response to movement through the container opening.

According to at least one example aspect, a transporter 20 is disclosed that comprises a platform 22 and a plurality of caster assemblies 24. The platform will be seen to comprise a rectangular steel sheet 26 defining a surface 28 and a plurality of steel members supporting the steel sheet surface and arranged to define a central slot 32 and a plurality of pockets 34. A plurality of lugs 36 and tie-offs 38 are provided on steel sheet 26. The caster assemblies 24 are provided for each pocket 34 and each comprise a castor 40, a locking plate 42, a trigger and an actuator 46. The castor is pivotally mounted to the platform 22 via a pin 48 and has an abutment surface 50. The locking plate is pivotally mounted to the platform via a shaft 52 and has an arresting surface 54. The trigger comprises a trigger plate 56 and a bias spring 58, the plate terminating in a camming surface 60. The actuator 46 can be implemented using an actuator spring.

In at least some example implementations, each caster assembly 24 will be understood to interoperate as follows: (i) the locking plate 42 is movable between a locking position and a release position; (ii) bias spring 58 biases the locking plate 42 for movement to the locking position; (iii) when the locking plate 42 is in the release position, the caster 40 is movable between an extended position shown in FIG. 4 and FIG. 5 and a retracted position shown in FIG. 3 and FIG. 6; (iv) the spring of actuator 46 biases the caster 40 for movement towards the extended position; (v) when the locking plate 42 is in the locking position and the caster 40 is in the extended position, the arresting surface 54 bears against the abutment surface 50 to lock the caster 40 against pivotal movement; (vi) when the locking plate 42 is in the locking position and the caster 40 is in the extended position, pressure on the camming surface 60 of the trigger plate 56 causes the locking plate 42 to move to the release position, thereby enabling the caster 40 to be urged against the bias of the spring of actuator 46 spring to the retracted position.

The transporter 20 as shown in FIG. 1 and FIG. 2, wherein all of the casters 40 are in the extended position, is suitable for transporting heavy loads placed on the surface 28. The transporter 20 can be usefully used with a conventional shipping container 100 having a pair of rearwardly facing doors 102 flanking an opening and having a floor 104. To do so, the doors of the container are opened and the transporter 20 is positioned adjacent the opening such that, in each caster assembly, the trigger is relatively proximal to the opening and the caster is relatively distal to the opening. Thereafter, the transporter is urged through the opening towards the front of the container. As each caster assembly reaches the opening, the camming surface engages the floor of the container, thereby causing the locking member to pivot to the release position and unlocking the caster for pivotal movement; the caster itself is caused to pivot to the retracted position by engagement with the container floor. The foregoing is illustrated in FIG. 9 and FIG. 10.

Withdrawal of the transporter from the container is equally convenient: as each caster breaches the container, it pivots to the extended position and is thereafter locked in place when its associated trigger breaches the container.

The Figures show details of an ejector 62 and a grappler 64 that can be usefully incorporated in the design. The ejector comprises: a central rail 66 mounted to the floor of the container; a chain loop 68 operatively mounted to the floor of the container; a gripper plate 70 operatively mounted to the chain loop; and a motor 72 operatively mounted to the chain loop. To expel the platform, the motor is engaged, to push the gripper plate towards the rear of the platform, and push the platform out of the container. A notch 74 can be defined in the platform to receive the gripper plate. The grappler can comprises a cable winch that can be used to draw the platform into the container.

A pivotably mounted tow bar 80 can be provide in some examples. The tow bar can be set upright during transport and can be pivoted downwardly to permit the platform to be manipulated into and out of the container by a truck or other vehicle.

A stability bracket 82 is shown in FIG. 13. In some examples, a protruding flange or bar on the platform 22 can engage this bracket 82 when the platform is fully enclosed in the container, securing the platform against sliding widthwise movement in the container.

Accordingly, the present disclosure provides apparatus, systems, and methods that can improve cargo handling relative to shipping containers by combining a load-supporting platform 22 with selectively deployable caster assemblies 24 and, in some embodiments, associated powered or manual handling features. The disclosed embodiments may be used individually or in combination, and features described in connection with one embodiment may be incorporated into another embodiment unless incompatible therewith. Thus, the present disclosure is to be understood as extending to variations, modifications, and combinations consistent with the teachings herein and as defined by the appended claims.

1. An apparatus for use with a shipping container and a floor, the shipping container being of a type that, when operatively disposed on the floor, defines an interior horizontal surface presenting upwardly for receiving cargo, the apparatus comprising:
a transporter comprising a platform and a plurality of casters, the platform defining a load-supporting surface and each of the plurality of casters being mounted to the platform for movement between a retracted position and an extended position; and
wherein the plurality of casters are configured such that, when the transporter exits the shipping container with the plurality of casters commencing in the retracted position, each caster traverses to the extended position upon exiting the shipping container to support the platform for rolling movement on the floor while the load-supporting surface remains at a substantially constant elevation relative to the floor.

2. The apparatus of claim 1, wherein each caster releasably locks upon movement to the extended position.

3. The apparatus of claim 2, wherein each caster has an associated trigger configured, when the apparatus is drawn into the shipping container from the floor, to release the caster for movement to the retracted position as the caster reaches the shipping container.

4. The apparatus of claim 1, wherein each caster has an associated actuator configured to move the caster to the extended position.

5. The apparatus of claim 4, wherein the actuator comprises a spring configured to bias the caster toward the extended position.

6. The apparatus of claim 1, wherein each caster is configured to be urged by the interior horizontal surface to the retracted position.

7. The apparatus of claim 1, wherein the transporter is configured for rolling movement when each caster is in the retracted position.

8. The apparatus of claim 1, further comprising a roller positioned to support the platform while at least one of the plurality of casters moves between the retracted position and the extended position.

9. The apparatus of claim 1, further comprising a tow bar pivotably mounted to the platform.

10. A cargo transport system comprising:
a shipping container comprising a floor and an opening; and
the apparatus of claim 1 positioned for movement through the opening relative to the floor.

11. The cargo transport system of claim 10, further comprising an ejector coupled to the shipping container and configured to expel the transporter from the shipping container.

12. The cargo transport system of claim 11, wherein the ejector comprises a chain loop operatively mounted to the shipping container, a plate operatively mounted to the chain loop and configured to engage the platform, and a motor operatively mounted to the chain loop.

13. The cargo transport system of claim 12, wherein the ejector comprises an elongate rail extending within the shipping container and supporting the chain loop and plate, wherein the platform defines a channel configured to receive the central rail.

14. The cargo transport system of claim 12, wherein the platform carries a latch configured to releasably engage the plate to enable the chain loop to move the platform bidirectionally with the plate.

15. The cargo transport system of claim 10, further comprising a grappler coupled to the shipping container and configured to draw the transporter into the shipping container.

16. The cargo transport system of claim 14, wherein the grappler comprises a cable winch.

17. The cargo transport system of claim 10, further comprising a stability bracket positioned to engage a protruding flange on the platform when the platform is fully enclosed in the shipping container to secure the platform against sliding widthwise movement in the shipping container.

18. A method of moving cargo relative to a shipping container, the shipping container comprising an interior horizontal surface and an opening, the method comprising:
disposing a transporter carrying the cargo adjacent the opening, the transporter comprising a platform and a plurality of casters mounted for movement between retracted positions and extended positions;
causing the transporter to move through the opening into or out of the shipping container; and
automatically moving the plurality of casters between the retracted positions and the extended positions responsive to the plurality of casters traversing the opening such that, when the transporter exits the shipping container, the platform is supported for rolling movement on a floor outside the shipping container while a load-supporting surface of the platform remains at a substantially constant elevation relative to the floor.

19. The method of claim 18, wherein moving the transporter into the shipping container comprises engaging a trigger associated with each caster against the interior horizontal surface to release the caster for movement to the retracted position.

20. The method of claim 18, wherein moving the transporter out of the shipping container comprises biasing each caster toward the extended position with an actuator as the caster exits the shipping container.
